(19) United States
(12) Patent Application Publication
(10) Pub. No.: US 2013/0057262 A1
(43) Pub. Date: Mar. 7, 2013

(54) Accelerator position sensor

(71) Applicants: Jong Sang Noh, Ulsan (KR); Eun Sik Kim, Daegu (KR); Bon Chang Koo, Gyeonggi-do (KR); Yang Rae Cho, Gyeonggi-do (KR); Bong Kyo Seo, Gyeonggi-do (KR)

(72) Inventors: Jong Sang Noh, Ulsan (KR); Eun Sik Kim, Daegu (KR); Bon Chang Koo, Gyeonggi-do (KR); Yang Rae Cho, Gyeonggi-do (KR); Bong Kyo Seo, Gyeonggi-do (KR)

(73) Assignees: Hyundai Motor Company, Seoul (KR); Donghee Industrial Co., Ltd., Nam-gu (KR); Kia Motors Corporation, Seoul (KR)

(21) Appl. No.: 12/501,614

(22) Filed: Jul. 13, 2009

(30) Foreign Application Priority Data
Dec. 4, 2008 (KR) 10-2008-122196

(51) Int. Cl. G01B 7/14

(52) U.S. Cl. 324/207.17

(57) ABSTRACT

An accelerator position sensor (APS) includes a transmitting coil generating a magnetic field, a coupler controlling the magnetic field generated from the transmitting coil, a receiving coil receiving the magnetic field generated from the transmitting coil to generate a predetermined frequency, and a signal processor calculating rotation information of the coupler using the frequency received from the receiving coil and outputting displacement values of an accelerator pedal. With the APS, a guarantee signal can be generated only through the receiving coil and precise measuring values can be achieved.

### CROSS-REFERENCE TO RELATED APPLICATION

This application claims under 35 U.S.C. §119(a) the benefit of Korean Patent Application No. 10-2008-0122196 filed on Dec. 4, 2008, the disclosure of which is incorporated herein by reference in its entirety.

### TECHNICAL FIELD

The present disclosure relates to an accelerator position sensor for a vehicle.

### BACKGROUND ART

An Accelerator Position Sensor (APS) is used for a vehicle to prevent the tires from slipping on a road surface and improving steering performance. The APS converts the force that a driver applies with his/her foot on an accelerator pedal into a voltage, based on which a computer can control an output power of the engine.

A conventional APS operates in a phased array mode or an oscillation amplitude mode. However, the APS operating in a phased array mode has problems in that it is hard to generate a precise guarantee signal, its structure is complex, and its manufacturing costs are expensive since linearity is achieved by dividing frequencies generated from a plurality of coils according to phases. The APS operating in an oscillation amplitude mode also has problems in that its circuit configuration is complex due to a guarantee coil added thereto, circuit substrate management is difficult due to additional printing of the guarantee coil, and its manufacturing costs are expensive.

The information disclosed in this Background Art section is only for enhancement of understanding of the background of the invention and should not be taken as an acknowledgement or any form of suggestion that this information forms the prior art that is already known to a person skilled in the art.

### SUMMARY

Embodiments of the present invention provide an Accelerator Position Sensor (APS) which can produce a guarantee signal using a receiving coil without spare guarantee coils.

In an exemplary embodiment of the present invention, an APS may include a transmitting coil connected to an oscillator, for generating a magnetic field; a coupler disposed at a predetermined interval from the transmitting coil, for controlling the magnetic field generated from the transmitting coil; a receiving coil disposed between the transmitting coil and the coupler, for receiving the magnetic field generated from the transmitting coil to generate a predetermined frequency; and a signal processor connected to the receiving coil, for calculating rotation information of the coupler using the frequency received from the receiving coil and outputting displacement values of an accelerator pedal.

In another exemplary embodiment of the present invention, the receiving coil may include a pair of symmetrical semi-circular parts, such that the frequency generated from the receiving coil can have a positive waveform and a negative waveform.

In a further exemplary embodiment of the present invention, the signal processor may generate a guarantee signal by rectifying the positive waveform and the negative waveform, generated from the receiving coil, into positive and negative voltages; producing an added value by adding the positive and negative voltages; producing a subtracted value by subtracting the negative voltage from the positive voltage; and dividing the subtracted value with the added value. In addition, the signal processor may amplify the generated guarantee signal, regulate a gain, and then output a plateau voltage.

According to embodiments of the present invention, since a spare guarantee coil is not required, a coil structure is simplified and coil printing is easy. Accordingly, the APS has a simple structure, with a decreased number of substrates, to thereby reduce manufacturing costs.

Furthermore, sensor allowance is reduced since programming is carried out using an ASIC chip. Accordingly, the load of Electronic Control Units (ECUs) can be reduced.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is an exploded perspective view illustrating a structure of an APS in accordance with an exemplary embodiment of the present invention.

FIG. 2 is a circuit diagram of the APS in accordance with the exemplary embodiment of the present invention.

FIG. 3 is a graph showing signals outputted from the APS in accordance with the exemplary embodiment of the present invention.

### DETAILED DESCRIPTION OF EMBODIMENTS

Hereinafter, an Accelerator Position Sensor (APS) according to embodiments of the present invention will be described more fully with reference to the accompanying drawings. In the following description of the present invention, unless otherwise indicated, a detailed description of known functions and components incorporated herein will be omitted when it may make the subject matter of the present invention rather unclear.

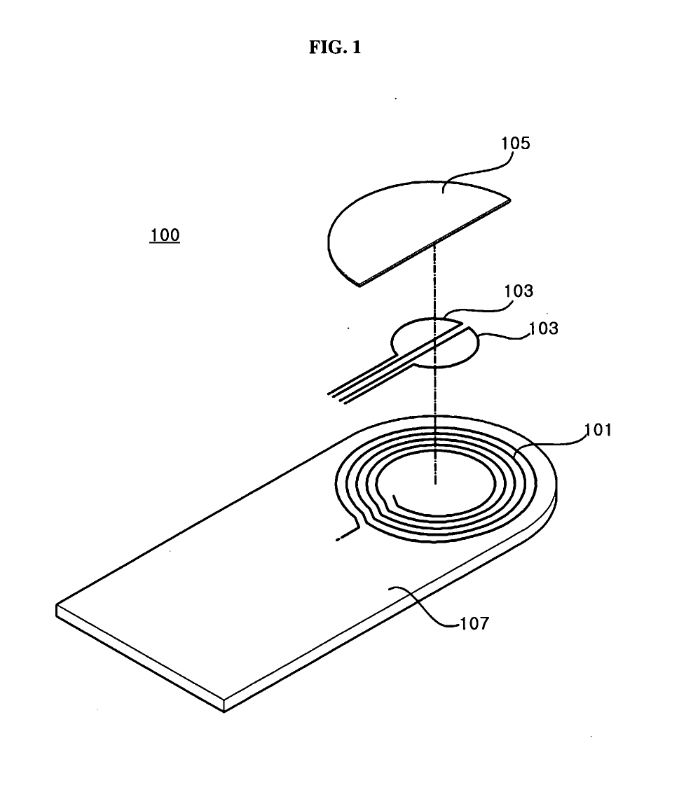

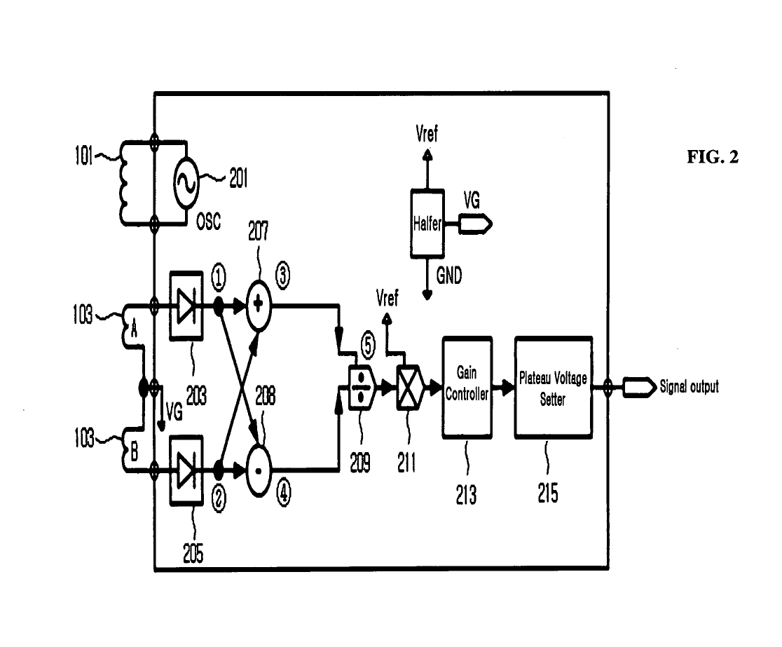

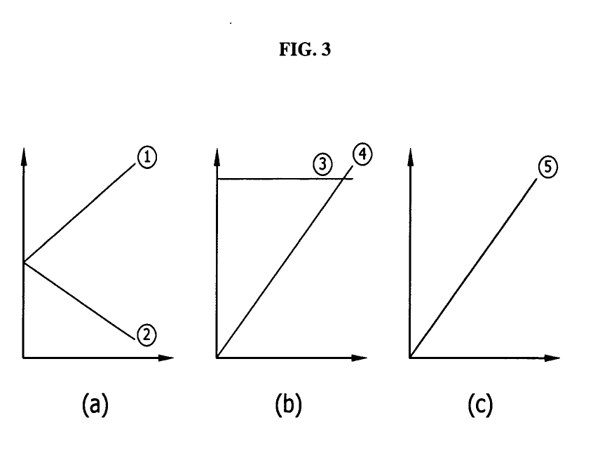

FIG. 1 is an exploded perspective view illustrating a structure of an APS in accordance with an exemplary embodiment of the present invention, FIG. 2 is a circuit diagram of the APS in accordance with the exemplary embodiment of the present invention, and FIG. 3 is a graph showing signals outputted from the APS in accordance with the exemplary embodiment of the present invention.

Referring to the figures, an APS 100 in accordance with an exemplary embodiment of the present invention includes a transmitting coil 101 connected to an oscillator 201 to generate a magnetic field, a coupler 105 disposed at a predetermined interval from the transmitting coil 101 to control the magnetic field generated from the transmitting coil 101, a receiving coil 103 disposed between the transmitting coil 101 and the coupler 105 to receive the magnetic field generated from the transmitting coil 101 and generate a predetermined frequency from the received magnetic field, and a circuit substrate 107 having a signal processor (not shown) connected to the receiving coil 103 to calculate rotation information of the coupler 105 using the frequency received from the receiving coil 103 and output displacement values of an accelerator pedal.

The transmitting coil 101 is printed on the circuit substrate 107 with a plurality of ring shapes, and the coupler 105 is formed with a semi-circular shape, and the receiving coil 103 is formed with a pair of symmetrical semi-circular parts.

In addition, the receiving coil 103 generates a predetermined frequency with receiving the magnetic field generated from the transmitting coil 101, while the coupler 105 can control the magnetic field. At this time, the generated frequency is composed of a positive waveform and a negative waveform. That is to say, as shown in FIGS. 1 and 2, since the receiving coil 103 is formed with the two symmetrical semi-circular parts, the positive waveform is generated from the first receiving coil part ‘A’ and the negative waveform is generated from the second receiving coil part ‘B.’

Accordingly, the positive waveform is rectified in a first rectifier 203, and the negative waveform is rectified in a second rectifier 205, thereby forming voltage signals \textcircled{1} and \textcircled{2}, respectively, as shown in (a) of FIG. 3.

The outputted voltages \textcircled{1} and \textcircled{2} are inputted into an adder 207 and a subtracter 208, which in turn output signals \textcircled{3} and \textcircled{4}, as shown (b) of FIG. 3. The output signals \textcircled{3} and \textcircled{4} are divided by a divider 209, thereby outputting a guarantee signal \textcircled{5}, as shown in (c) of FIG. 3.

More particularly, the adder 207 calculates a value by adding the voltage signals \textcircled{1} and \textcircled{2} (i.e., \textcircled{1}+\textcircled{2}), the subtracter 208 calculates a value by subtracting the voltage signal \textcircled{2} from the voltage signal \textcircled{1} (i.e., \textcircled{1}−\textcircled{2}), and the divider 29 calculates a value by dividing the subtracted value by the added value (i.e., \textcircled{1}−\textcircled{2}/\textcircled{1}+\textcircled{2})). For example, the divider 209 can divide the output value of the subtracter 208 with the output value of the adder 207 according to a ratio-metric method.

Here, preferably, the signal processor can be implemented with an Application Specific Integrated Circuit (ASIC). According to the construction and process as described above, outside noise is cancelled and thus electromagnetic wave characteristics are improved.

The outputted guarantee signal is amplified through a signal amplifier 211, and a gain of the amplified signal is regulated through a gain controller 213, and a plateau voltage setter 215 then outputs a plateau voltage of the signal in which the gain is regulated.

Accordingly, a guarantee signal can be generated only through the receiving coil, and precise measuring values can be achieved through the signal processor.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. An accelerator position sensor for a vehicle, comprising:
a transmitting coil connected to an oscillator, for generating a magnetic field;
a coupler disposed at a predetermined interval from the transmitting coil, for controlling the magnetic field generated from the transmitting coil;
a receiving coil disposed between the transmitting coil and the coupler, for receiving the magnetic field generated from the transmitting coil to generate a predetermined frequency; and
a signal processor connected to the receiving coil, for calculating rotation information of the coupler using the frequency received from the receiving coil and outputting displacement values of an accelerator pedal.

2. The accelerator position sensor according to claim 1, wherein the receiving coil comprises a pair of symmetrical semi-circular parts, such that the frequency generated from the receiving coil has a positive waveform and a negative waveform.

3. The accelerator position sensor according to claim 2, wherein the signal processor generates a guarantee signal by: rectifying the positive waveform and the negative waveform, generated from the receiving coil, into positive and negative voltages; producing an added value by adding the positive and negative voltages; producing a subtracted value by subtracting the negative voltage from the positive voltage; and dividing the subtracted value with the added value.

4. The accelerator position sensor according to claim 3, wherein the signal processor amplifies the generated guarantee signal, regulates a gain, and then outputs a plateau voltage.
